(19) United States
(12) Patent Application Publication
(10) Pub. No.: US 2002/0050378 A1
(43) Pub. Date: May 2, 2002

(54) Double-layered multiple chip module package

(76) Inventors: Kuo-Ning Chiang, Tao-Yen (TW); Wen-Hwa Chen, Hsin-Chu (TW); Kuo-Tai Tseng, Kao-Hsiang (CN)

Correspondence Address: Hung Chang LIN, 8 Schindler Court, Silver Spring, MD, 20903, US

(21) Appl. No.: 09/863,784

(22) Filed: May 24, 2001

Related U.S. Application Data
(63) Continuation-in-part of application No. 09/323,648, filed on Jun. 1, 1999, now abandoned.
(63) Continuation-in-part of application No. 09/298,859, filed on Apr. 26, 1999, now abandoned.

(51) Int. Cl. H02G 3/08

(52) U.S. Cl. 174/52.1

(57) ABSTRACT

The IC chips of a multiple IC chip module are mounted in stack in a ceramic substrate, which has good heat dissipating capability. At least one IC chip is mounted on top of the ceramic substrate and at least one other IC chip is mounted at the bottom of the ceramic substrate. The bonding pads along the periphery of the ceramic substrate are lead-bonded to a second substrate with printed wiring on at least one of the surfaces and solder connection at the bottom. The IC chip is separated from the second substrate by a resin to cushion the stress due to difference in thermal expansion coefficients of the IC chip and the second substrate.

### BACKGROUND OF THE INVENTION

(1) Field of the Invention

This invention relates to integrated circuit package, in particular to multiple chip module (MCM) package. This application is a continuation-in-part patent application of application 09/323.648, filed Jun. 6, 1999, and copending with application 09/298,859 filed Apr. 26, 1999.

(2) Description of the Related Art

As memory capacity of an integrated circuit chip increases from 4 M, 16 M, 64 M, 128 M to 256 M, the manufacturing difficulty also increases and the manufacturing yield decreases. Another approach in increasing the memory capacity is to improve the packaging technique. For instance, a 128 M memory can be obtained by packaging two 64 M chips in one package, known as Multi-chip Module (MCM). In this manner, the yield can be increased and the manufacturing difficulty can be reduced.

Another popular packaging technique is the micro Ball Grid Array (μBGA) package. FIG. 1A shows the use of μBGA for a single IC chip 10. The IC chip 10 has bonding pads 12 along the periphery which are bonded through bonding wires 16 to the bottom of substrate 14, as shown in FIG. 1B. The IC chip 10 is separated from the substrate 14 by a resin 15, which serves to cushion the difference in thermal expansion of the IC chip 10 and the substrate 14. The substrate 14 has solder connection 18 at the bottom of the substrate 14 for surface mounting to a printed circuit board.

The structure shown in FIGS. 1A and 1B does not have provision to dissipate the heat generated in IC chip 10 because the resin 15 is a poor heat conductor. Another problems of the structure is that only one IC chip can be mounted over the substrate 14. The problem is more serious for modern VLSI IC chip where large amount of heat may be generated. Another shortcoming of the structure is that only one IC chip can be mounted over the substrate 14 and the packing density is limited.

In U.S. Pat. No. 5,450,283, Lin disclosed a resin material between the IC chip and a substrate to reduce stress due to difference in thermal expansion of the chip and the substrate. The chip is supported by solder bumps from the substrate and forms a unitary body with the substrate through the solid solder links. The resin is inserted in the same side with the solder bumps to fill the space between the solder bumps. The resin is to reinforce the adhesion between the active side of the chip and the substrate, so that any shearing force exerted on the chip can be resisted. Hence, the harder the resin, the better it is. Such a unitary structure cannot effectively relieve the thermal stress due to relative horizontal expansions of the chip and the substrate.

Tanioka disclosed in U.S. Pat. No. 5,784,264 a conductive material between the IC chips and a substrate to reduce alpha particle radiation. The conductive material is unsuitable to provide isolation and to relieve thermal stress between the IC chips and the substrate.

### BRIEF SUMMARY OF THE INVENTION

An object of this invention is to increase the heat dissipation capability of a MCM package. Another object of this invention is to provide a solder connection package for MCM. Still another object of this invention is to increase the packing density of a MCM,

These objects are achieved in this invention by using ceramic substrate as a circuit board for more than one IC chip. At least one IC chip is attached to the bottom of the ceramic substrate and at another IC chip is stacked over the top of the ceramic substrate. By stacking the IC chips, the packing density is increased. The pads on the ceramic substrate is then lead-bonded to a second substrate with a ball grid array at the bottom. The IC chips are isolated from the second substrate with a resin cushion.

### BRIEF DESCRIPTION OF THE SEVERAL VIEWS OF THE DRAWINGS

FIG. 1A shows the side view of a prior art BGA package;

FIG. 1B shows a bottom view of the prior art BGA package.

FIG. 2A shows the side view of a BGA package of the present invention for two stacked IC chips;

FIG. 2B show the side view of the BGA package for a three chip IC chips;

FIG. 2C shows the bottom view of the FIG. 2A or FIG. 2B.

FIG. 3A shows a side view of another embodiment of a BGA package for three IC chips;

FIG. 3B shows another version of a BGA package for four IC chips;

FIG. 3C shows the bottom view of the structure shown in FIG. 3A or FIG. 3B.

FIG. 4 shows the bottom view of structure with a double-sided BGA package.

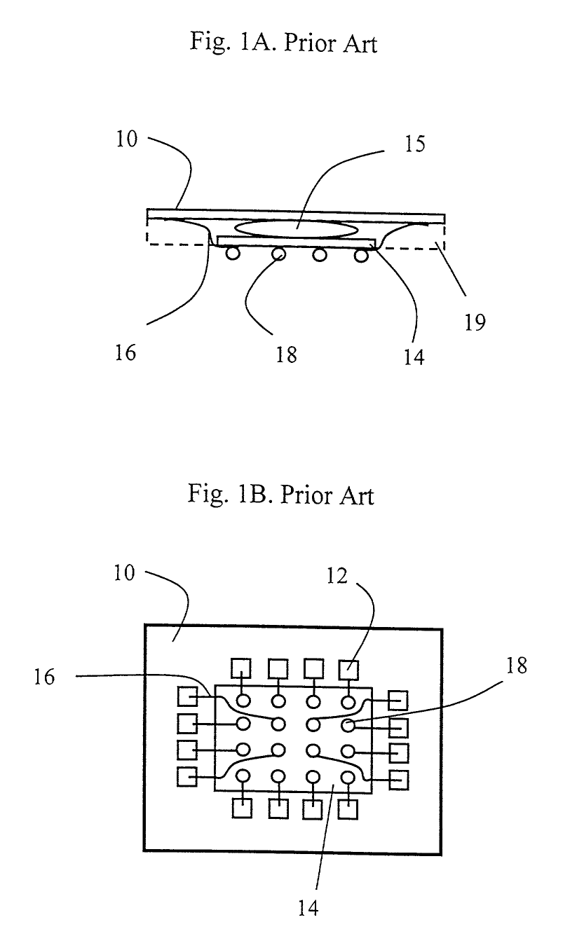

### DETAILED DESCRIPTION OF THE INVENTION

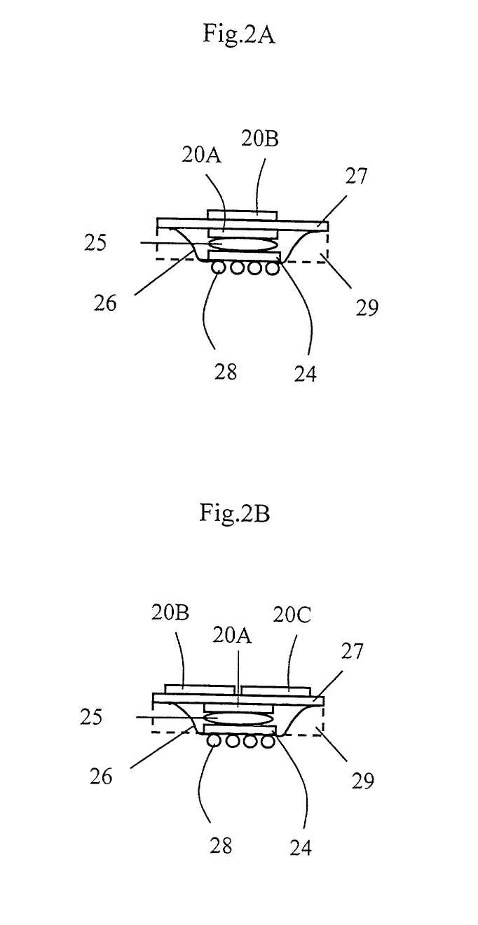

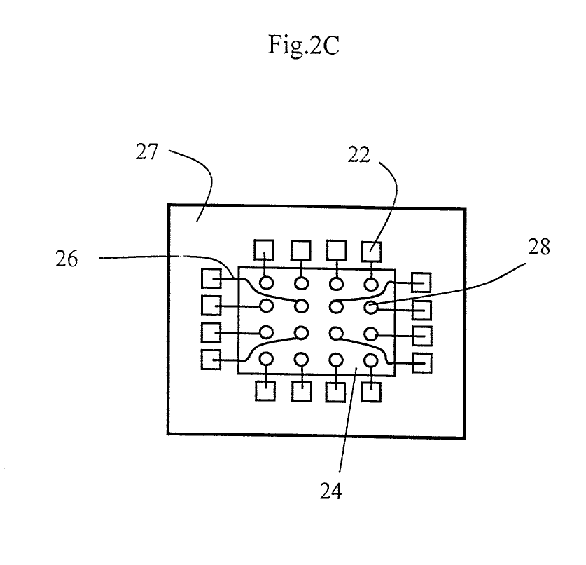

FIG. 2A shows the side view of a BGA package for two IC chips based on the present invention. A ceramic substrate 27 with electric wiring (not shown) is coupled to an IC chip 20A in the bottom and another IC chip 20B on the top. The ceramic substrate 27 has greater heat dissipation capability than an organic substrate. A second substrate 24 with printed circuit on bottom 17 and solder connection 28 at the bottom serving as IO terminals for the IC chips 20A and 20B. The terminal bonding pads 22 for the IC chips 20A and 20B are placed at the periphery of the ceramic substrate 27 and lead-bonded through wires 26 to the bottom of substrate 24, which has electrical line to reach the solder connection 28 at the bottom of substrate 24, serving as I/O terminals for the IC chips 20A and 20B.

The bottom IC chip 20A is separated from the substrate 24 by a non-conductive resin buffer 25, which serves as a cushion to reduce the effect of non-matching thermal expansion and contraction of the IC chip and the substrate 24 and to provide isolation the IC chip and the substrate. The resin buffer 25 should be of soft elastic material, which does not cover any solder bumps, as contrasted from Lin's prior art, and can be a single body or multiple units.

The structure can be sealed in a glue 29 to protect the IC chip 20, bonding wires 26, etc. and to protect against moisture in the air.

FIG. 2B shows the side view of FIG. 2A.

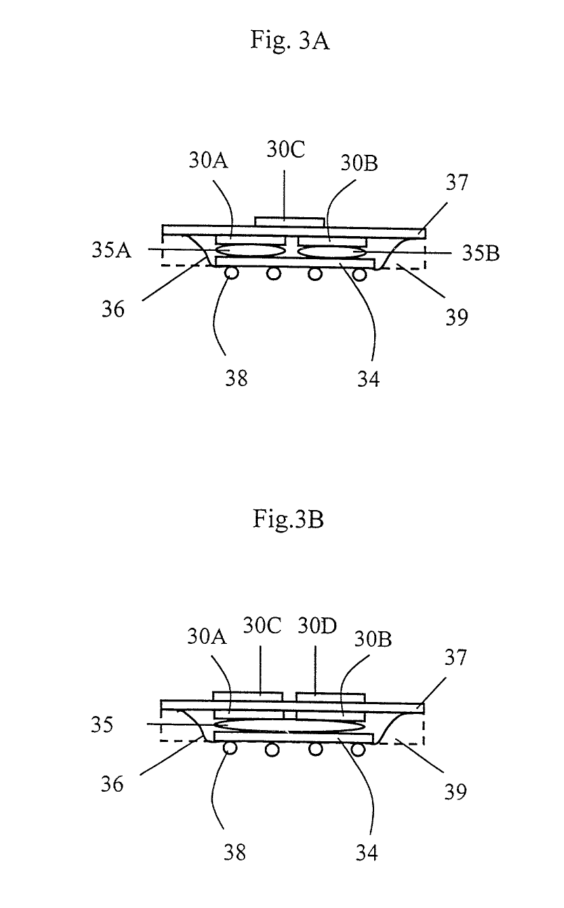

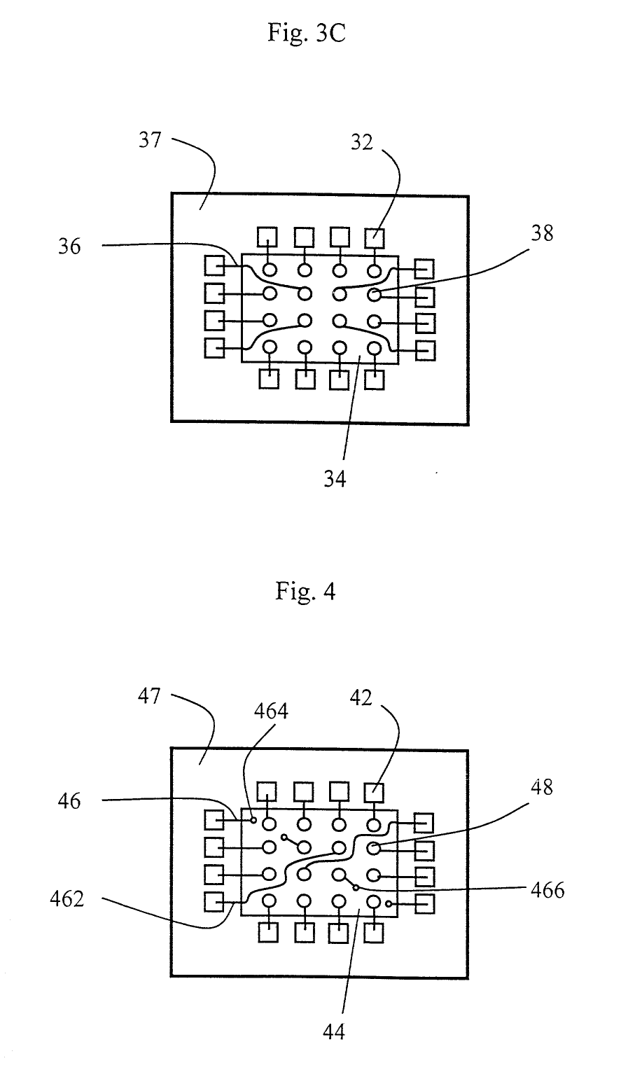

FIG. 3A shows a side view of a BGA package for multiple IC chips based on the present invention. A ceramic substrate 37 with printed wiring (not shown) is coupled to a number of IC chips such as 30A, 30B and 30C. A second substrate 34, such as BGA substrate, with printed wiring on bottom and solder connection at the bottom serving as I/O terminals for the IC chips 30A ,30B, 30C. The terminal bonding pads for the IC chips 30A, 30B and 30C are placed at the periphery of the ceramic substrate 37 and lead-bonded through wires 36 to the bottom of substrate 34, which has electrical lines to reach solder connections 38 at the bottom of substrate 34 serving as I/O terminals for the IC chips 30A, 30B and 30C.

The IC chips 30A and 30B are separated from the substrate 34 by two resin blocks 35A and 35B, respectively, which serve to reduce the effect of non-matching thermal expansion and contraction of the IC chips 30A, 30B and the substrate 34. The resin buffer 35A, 35B can be a single block as shown in FIG. 3B or multiple blocks as shown in FIG. 3A.

FIG. 3B shows a structure with two IC 30A and 30B coupled to the bottom of the ceramic substrate 37, and another two ICs 30C and 30D coupled to the top of the substrate 37. The two bottom ICs 30A and 30B are separated from a second substrate 34 by a single resin block 35, which serves to reduce the effect of non-matching thermal expansion and contraction of the IC chips 30A, 30B and the substrate 34.

The BGA substrate 24 in FIG. 2B and the BGA substrate 34 in FIGS. 3A, 3B, 3C can be a single-sided printed-wiring or a double-sided printed wiring substrate 47 as shown in FIG. 4. With a two-sided printed wiring substrate, multiple-layered interconnection is made possible. In FIG. 4, the BGA substrate 44 is mounted below a ceramic substrate 47 with bonding pads 42 placed along the periphery of the ceramic substrate 47. Bonding wires such as wire 462 are connected to the solder balls such as solder ball 48. Other bonding wires such as wire 46 at the northwest corner of ceramic substrate 47 is intended to be connected to the southeast corner of the BGA substrate 44. However, a direct wire connection from the northwest corner of the ceramic substrate 47 to the southeast corner of the BGA substrate would require crossing the wire 462 and cause short-circuiting between wire 46 and wire 462. The problem is alleviated by using a double-sided multiple-layered printed wiring BGA substrate 44. With a double-sided printed wiring BGA substrate 44, the incoming lead wire 46 is connected through a via hole 464 to printed wiring on the top side of the BGA substrate 44. Through the printed wiring on the top of the BGA substrate 44 and another via hole 466, the lead wire 46 is made conductive to the southeast corner of the BGA substrate and be connected to an adjacent solder ball through a printed wire.

The structure can be sealed in a glue 39 to protect the IC chips 30A, 30B, bonding wires, etc. and to protect against moisture in the air.

In the foregoing embodiments where ball grid array is used, it can be replaced with solder bumps or solder pads. Also, the connection to the bonding pad of the ceramic substrate can be either lead-bonded or wire-bonded.

While particular embodiments of the invention have been described, it will be apparent to those skilled in the art that various modifications may be made in the embodiments without departing from the spirit of the present invention. Such modifications are all within the scope of this invention.

1. A stacked multiple-chip module (MCM) package for integrated circuit (IC) chip, comprising:
IC chips;
a ceramic substrate with electric wiring to which at least one of said IC chips is attached at the top of said substrate and at least one of said IC chips is attached at the bottom of said substrate, and with bonding pads along the periphery of said ceramic substrate;
a second substrate having printed wiring on at least one of the surfaces to which the bonding pads of said ceramic substrate is bonded and having solder connection at the bottom surface connected to the printed wiring; and
at least one non-conductive resin block placed between said IC chips attached to the bottom of IC chips and said second substrate to cushion the stress due to difference in temperature coefficient between the IC chips and the second substrate.

2. A stacked MCM package as described in claim 1, wherein there are only two said IC chips, one above said ceramic substrate and another one beneath said ceramic substrate.

3. A stacked MCM package as described in claim 1, wherein said MCM package is sealed in glue.

4. A stacked MCM package as described in claim 1, wherein there is one said at least one non-conductive resin block and three said IC chips, two above said ceramic substrate and one below said ceramic substrate.

5. A stacked MCM package as described in claim 1, wherein there are two of said at least one non-conductive resin block and three said IC chips, one above said ceramic substrate and two below said ceramic substrate.

6. A stacked MCM package as described in claim 1, wherein the bonding pads of said ceramic substrate are lead-bonded.

7. A stacked MCM package as described in claim 1, wherein the bonding pads of said ceramic substrate are wire-bonded.
